(19) United States
(12) Patent Application Publication
(10) Pub. No.: US 2024/0384819 A1
(43) Pub. Date: Nov. 21, 2024

(54) THREADED TUBULAR MEMBERS EMPLOYING METAL-TO-METAL SEALS

(71) Applicant: National Oilwell Varco, L.P., Houston, TX (US)

(72) Inventors: Lalit Chandra Sekhar Karlapalem, Tomball, TX (US); Richard C. Griffin, Cypress, TX (US); Andrei Muradov, Houston, TX (US)

(73) Assignee: National Oilwell Varco, L.P., Houston, TX (US)

(21) Appl. No.: 18/669,291

(22) Filed: May 20, 2024

Related U.S. Application Data
(60) Provisional application No. 63/503,106, filed on May 18, 2023.

(51) Int. Cl. F16L 15/00; E21B 17/042; F16L 15/06

(52) U.S. Cl. CPC F16L 15/001; E21B 17/042; F16L 15/06

(57) ABSTRACT

A threaded connection between an end of a first tubular member having a central axis and an end of a second tubular member having a central axis coaxially aligned with the central axis of the first tubular member includes a threaded box connector disposed at the end of the first tubular member. The threaded box connector includes a box external shoulder, a box internal shoulder axially spaced from the box external shoulder, a plurality of internal threads axially positioned between the box external shoulder and the box internal shoulder, and a box seal surface axially positioned between the internal threads and the box internal shoulder. In addition, the threaded connection includes a threaded pin connector disposed at the end of the second tubular member and threadably coupled to the threaded box connector. The threaded pin connector includes a pin external shoulder that engages the box external shoulder, a pin internal shoulder axially spaced from the pin external shoulder, a plurality of external threads axially positioned between the pin external shoulder and the pin internal shoulder, and a pin nose extending axially from the plurality of external threads to the pin internal shoulder. The pin internal shoulder engages the box internal shoulder. The external threads of the threaded pin connector mate with and threadably engage the internal threads of the threaded box connector. The pin nose includes a pin seal surface that sealingly engages the box seal surface and a major pin nose section extending axially from the external threads to the pin seal surface. The pin nose has a length Lp-nose measured axially from the plurality of external threads to the pin internal shoulder, wherein the length Lp-nose is greater than or equal to 1.625 in.

### CROSS-REFERENCE TO RELATED APPLICATIONS

This application claims benefit of U.S. provisional patent application Ser. No. 63/503,106 filed May 18, 2024, and entitled “Threaded Tubular Members Employing Metal-to-Metal Seals,” which is hereby incorporated herein by reference in its entirety for all purposes.

### BACKGROUND

This disclosure relates generally to threaded connections. More particularly, this disclosure relates to radial metal-to-metal seals on threaded connections for downhole tubulars such as drill pipes.

Threaded tubulars are common in many industrial applications, such as, for example, oil and gas drilling, production, transportation, refining, etc. For example, in oil and gas drilling operations, a drill bit is threadably attached at one end of a threaded tubular and the tubular is rotated (e.g., from the surface, downhole by a mud motor, etc.) in order to form a borehole. As the bit advances within the formation, additional tubulars are threadably attached end-to-end at the surface, thereby forming an elongate drill string. While the drill bit is rotated, drilling fluid is pumped down the drill string, directed out of the face of the drill bit, and then flows back to the surface via an annulus between the drill string and the borehole sidewall.

### BRIEF SUMMARY OF THE DISCLOSURE

Embodiments of threaded connections between an end of a first tubular member having a central axis and an end of a second tubular member having a central axis coaxially aligned with the central axis of the first tubular member are disclosed herein. In one embodiment, a threaded connection comprises a threaded box connector disposed at the end of the first tubular member. The threaded box connector comprises a box external shoulder, a box internal shoulder axially spaced from the box external shoulder, a plurality of internal threads axially positioned between the box external shoulder and the box internal shoulder, and a box seal surface axially positioned between the internal threads and the box internal shoulder. In addition, the threaded connection comprises a threaded pin connector disposed at the end of the second tubular member and threadably coupled to the threaded box connector. The threaded pin connector comprises a pin external shoulder that engages the box external shoulder, a pin internal shoulder axially spaced from the pin external shoulder, a plurality of external threads axially positioned between the pin external shoulder and the pin internal shoulder, and a pin nose extending axially from the plurality of external threads to the pin internal shoulder. The pin internal shoulder engages the box internal shoulder. The external threads of the threaded pin connector mate with and threadably engage the internal threads of the threaded box connector. The pin nose includes a pin seal surface that sealingly engages the box seal surface and a major pin nose section extending axially from the external threads to the pin seal surface. The pin nose has a length Lp-nose measured axially from the plurality of external threads to the pin internal shoulder, wherein the length Lp-nose is greater than or equal to 1.625 in.

In another embodiment, a threaded connection comprises a threaded box connector disposed at the end of the first tubular member. The threaded box connector comprises a box external shoulder, a box internal shoulder axially spaced from the box external shoulder; a plurality of internal threads axially positioned between the box external shoulder and the box internal shoulder; and a box seal surface axially positioned between the internal threads and the box internal shoulder. In addition, the threaded connection comprises a threaded pin connector disposed at the end of the second tubular member and threadably coupled to the threaded box connector. The threaded pin connector comprises a pin external shoulder that engages the box external shoulder, a pin internal shoulder axially spaced from the pin external shoulder, a plurality of external threads axially positioned between the pin external shoulder and the pin internal shoulder, and a pin nose extending axially from the plurality of external threads to the pin internal shoulder. The pin internal shoulder engages the box internal shoulder. The external threads of the threaded pin connector mate with and threadably engage the internal threads of the threaded box connector. The pin nose includes a pin seal surface that sealingly engages the box seal surface, a major pin nose section extending axially from the external threads to the pin seal surface, and a minor pin nose section extending axially from the pin seal surface to the pin internal shoulder. The pin nose has a length Lp-nose measured axially from the plurality of external threads to the pin internal shoulder. The major pin nose section has a length Lp-major measured axially from the external threads to the pin seal surface. The ratio of the length Lp-major to the length Lp-nose is greater than or equal to 0.25.

In yet another embodiment, a threaded connection comprises a threaded box connector disposed at the end of the first tubular member. The threaded box connector comprises a box external shoulder, a box internal shoulder axially spaced from the box external shoulder, a plurality of internal threads axially positioned between the box external shoulder and the box internal shoulder, and a box seal surface axially positioned between the internal threads and the box internal shoulder. In addition, the threaded connection comprises a threaded pin connector disposed at the end of the second tubular member and threadably coupled to the threaded box connector. The threaded pin connector comprises a pin external shoulder that engages the box external shoulder, a pin internal shoulder axially spaced from the pin external shoulder, a plurality of external threads axially positioned between the pin external shoulder and the pin internal shoulder, and a pin nose extending axially from the plurality of external threads to the pin internal shoulder. The pin internal shoulder engages the box internal shoulder. The external threads of the threaded pin connector mate with and threadably engage the internal threads of the threaded box connector. The pin nose includes a pin seal surface that sealingly engages the box seal surface, a major pin nose section extending axially from the external threads to the pin seal surface, and a minor pin nose section extending axially from the pin seal surface to the pin internal shoulder. The major pin nose section has a length Lp-major measured axially from the external threads to the pin seal surface. The minor pin nose section has a length Lp-minor measured axially from the pin seal surface to the pin internal shoulder. The ratio of the length Lp-minor to the length Lp-major is greater than or equal to 0.10 and less than or equal to 0.50.

In still a further embodiment, a threaded connection comprises a threaded box connector disposed at the end of the first tubular member. The threaded box connector comprises a box external shoulder, a box internal shoulder axially spaced from the box external shoulder, a plurality of internal threads axially positioned between the box external shoulder and the box internal shoulder, a box seal surface axially positioned between the internal threads and the box internal shoulder, a first transition surface extending axially from the internal threads to the box seal surface, and a second transition surface extending axially from the box seal surface to the box internal shoulder. The box seal surface has a length Lb-seal measured axially from the first transition surface to the second transition surface. In addition, the threaded connection comprises a threaded pin connector disposed at the end of the second tubular member and threadably coupled to the threaded box connector. The threaded pin connector comprises a pin external shoulder that engages the box external shoulder, a pin internal shoulder axially spaced from the pin external shoulder, a plurality of external threads axially positioned between the pin external shoulder and the pin internal shoulder, and a pin nose extending axially from the plurality of external threads to the pin internal shoulder. The pin internal shoulder engages the box internal shoulder. The external threads of the threaded pin connector mate with and threadably engage the internal threads of the threaded box connector. The pin nose includes a pin seal surface that sealingly engages the box seal surface, a major pin nose section extending axially from the external threads to the pin seal surface, and a minor pin nose section extending axially from the pin seal surface to the pin internal shoulder. The pin seal surface has a length Lp-seal measured axially from the major pin nose section to the minor pin nose section. The length Lp-seal is greater than the length Lb-seal. The pin seal surface extends axially from the box seal surface toward the pin external shoulder and the pin seal surface extends axially from the box seal surface toward the pin internal shoulder.

Embodiments described herein comprise a combination of features and advantages intended to address various shortcomings associated with certain prior devices, systems, and methods. The foregoing has outlined rather broadly the features and certain technical advantages of the disclosed exemplary embodiments in order that the detailed description that follows may be better understood. The various characteristics described above, as well as other features, will be readily apparent to those skilled in the art upon reading the following detailed description, and by referring to the accompanying drawings. It should be appreciated by those skilled in the art that the conception and the specific exemplary embodiments disclosed may be readily utilized as a basis for modifying or designing other structures for carrying out the same purposes of the embodiments described herein.

### BRIEF DESCRIPTION OF THE DRAWINGS

For a detailed description of the disclosed exemplary embodiments, reference will now be made to the accompanying drawings in which:

FIG. 1 is a schematic side view of an embodiment of a drilling system for drilling a borehole into a subterranean formation in accordance with the principles disclosed herein;

FIG. 2 is a perspective cross-sectional view of one of the drill pipes for use within the drilling system of FIG. 1;

FIG. 3 is a side cross-sectional view of one of the drill pipes for use within the drilling system of FIG. 1;

FIG. 4 is an enlarged cross-sectional view of the threaded connection between the pin connector of one drill pipes of FIG. 1 and the mating box connector of an adjacent drill pipe of FIG. 1;

FIG. 5 is an enlarged view of the pin end threaded connector of FIG. 4;

FIG. 6 is an enlarged view of the box end threaded connector of FIG. 4;

FIG. 7 is an enlarged cross-sectional view of an embodiment of a threaded connection between a pin connector of a tubular member and a mating box connector of an adjacent tubular member in accordance with the principles disclosed herein;

FIG. 8 is an enlarged view of the pin end threaded connector of FIG. 7;

FIG. 9 is an enlarged view of section 9-9 of FIG. 7; and

FIG. 10 is an enlarged cross-sectional view of an embodiment of a threaded connection between a pin connector of a tubular member and a mating box connector of an adjacent tubular member in accordance with the principles disclosed herein.

### DETAILED DESCRIPTION OF EXEMPLARY EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. Any reference to up or down in the description and the claims is made for purposes of clarity, with “up”, “upper”, “upwardly”, “uphole”, or “upstream” meaning toward the surface of the borehole and with “down”, “lower”, “downwardly”, “downhole”, or “downstream” meaning toward the terminal end of the borehole, regardless of the borehole orientation. As used herein, the words “approximately” and “substantially” mean plus or minus 10%.

As previously described, during drilling operations, a drill string is formed by threadably connecting tubulars together end-to-end, and rotating a drill bit at the lower end of the drill string while simultaneously flowing fluid down the drill string to drill a borehole in a formation along a desired trajectory. During such operations, it is desirable that the threaded connections exhibit sufficient corrosion resistance and strength (e.g., tensile strength). It is also desirable that the threaded connections form and maintain gas-tight seals at relatively high internal gas pressures, while exhibiting sufficient durability and robustness to do so (i.e., maintain the gas-tight seals) after repeated threading and unthreading of the connections (i.e., repeated making and breaking of the threaded connections).

Some conventional threaded connections for use in oil and gas operations offer metal-to-metal seals. However, some of those conventional threaded connections (e.g., threaded connections along casing) are designed to operate under different design requirements than drill pipe. In addition, many of those conventional threaded connections are not designed to withstand repeated make and break cycles as they often rely on interference threads and tapered shoulders (reverse or negative angled shoulders) to form the metal-to-metal seals. Such characteristics are not typical for drill pipe, which have non-interference threads, also referred to as free-running threads, and planar shoulders to withstand relatively high make-up torque and number of make and break cycles. Accordingly, embodiments of threaded connections described herein are directed to threaded connections that offer the potential to provide the desired corrosion resistance, strength, and robustness to ensure gas-tight seals at relatively large internal fluid pressures (e.g., upwards of 20,000 psi) after repeated make and break cycles. Although embodiments of threaded connections disclosed herein may be described in the context of drilling operations and drill pipe, it should be appreciated that the embodiments of tubular members and threaded connections disclosed herein can also be used in other applications such as for casing, tubing, completion and workover risers, marine risers, and the like.

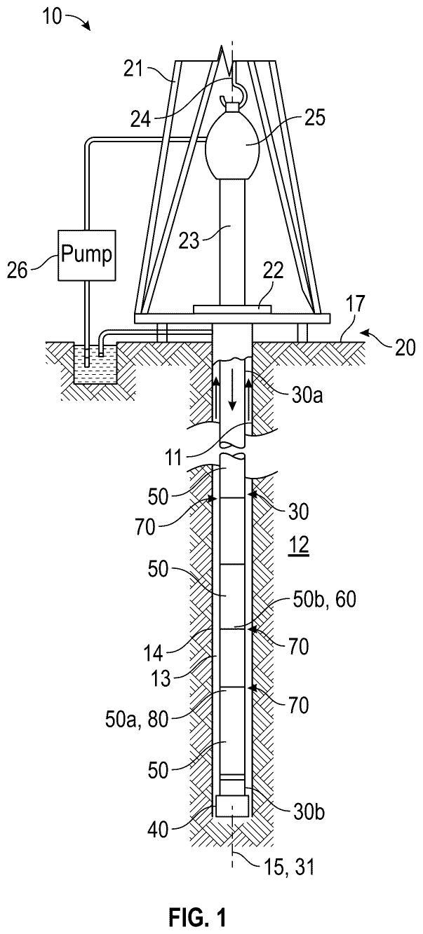

Referring now to FIG. 1, an embodiment of a drilling system 10 is schematically shown. In this embodiment, drilling system 10 includes a drilling rig 20 positioned over a borehole 11 penetrating a subsurface formation 12, a casing 14 extending from the surface 17 into the upper portion of borehole 11 along a central or longitudinal axis 15, and a drillstring 30 suspended in borehole 11 from a derrick 21 of rig 20. Drillstring 30 has a central or longitudinal axis 31 that, in this embodiment, is aligned with axis 15 of casing 14 (note: such alignment is not required), a first or uphole end 30a coupled to derrick 21, and a second or downhole end 30b opposite end 30a. In addition, drillstring 30 includes a drill bit 40 at downhole end 30b, and a plurality of tubular members 50 extending from bit 40 to uphole end 30a. Tubular members 50 are connected end-to-end, and bit 40 is connected to a lower end of the lowermost pipe 50. As tubular members 50 are used to form drillstring 30, tubular members 50 may also be referred to herein as “drill pipes” or “pipe joints” as are terms commonly used in the art. A bottomhole assembly (BHA) (not shown) can be disposed in drill string 30 proximal the bit 40 (e.g., axially between bit 40 and the lowermost pipe 50).

In this embodiment, drill bit 40 is rotated by rotation of drill string 30 from the surface 17. In particular, drill string 30 is rotated by a rotary table 22 that engages a kelly 23 coupled to uphole end 30a of drillstring 30. Kelly 23, and hence drill string 30, is suspended from a hook 24 attached to a traveling block (not shown) with a rotary swivel 25 that permits rotation of drill string 30 relative to derrick 21. Although drill bit 40 is rotated from the surface 17 with drill string 30 in this embodiment, in general, the drill bit (e.g., drill bit 40) can be rotated with a rotary table or a top drive, rotated by a downhole mud motor disposed in the BHA, or combinations thereof (e.g., rotated by both rotary table via the drillstring and the mud motor, rotated by a top drive and the mud motor, etc.). For example, rotation via a downhole motor may be employed to supplement the rotational power of a rotary table 22, if required, and/or to effect changes in the drilling process. Thus, it should be appreciated that the various aspects disclosed herein are adapted for employment in each of these drilling configurations.

During drilling operations, a mud pump 26 at the surface 17 pumps drilling fluid or mud down the interior of drill string 30 via a port in swivel 25. The drilling fluid exits drill string 30 through ports or nozzles in the face of drill bit 40, and then circulates back to the surface 17 through the annulus 13 radially disposed between drill string 30 and the sidewall of borehole 11. The drilling fluid functions to lubricate and cool drill bit 40, carry formation cuttings to the surface, and maintain the pressure necessary to prevent blowouts. As described above, embodiments of tubular members and threaded connections disclosed herein can also be used in other applications such in completion operations, intervention operations, and production operations.

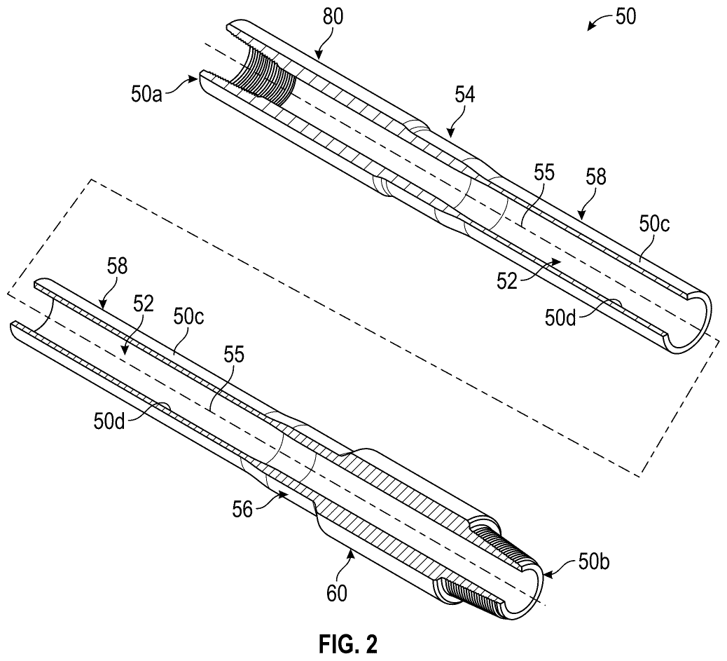

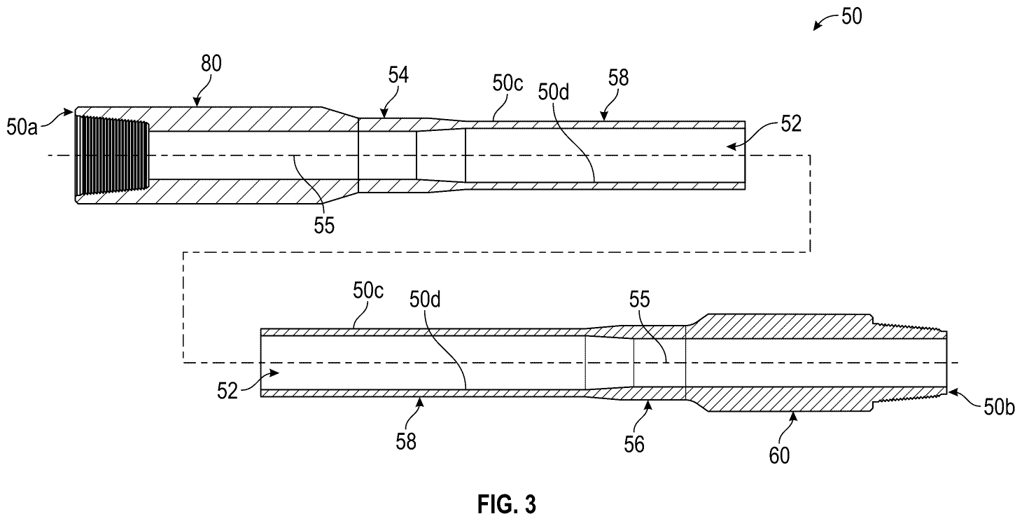

Referring now to FIGS. 2 and 3, each drill pipe 50 making up drill string 30 is an elongate tubular member is threadably connected to each adjacent drill pipe 50 or other component (e.g., drill bit 40, BHA, etc.). In particular, each drill pipe 50 is threadably connected to an adjacent drill pipe 50 at a threaded connection 70.

Each drill pipe 50 includes a central or longitudinal axis 55 that is aligned with axis 31 of drill string 30 during operations, a first or upper end 50a, a second or lower end 50b opposite upper end 50a, a radially outer surface 50c extending axially between ends 50a, 50b, and a radially inner surface 50d defining a throughbore 52 that also extends axially between ends 50a, 50b.

A threaded connector is disposed at each end 50a, 50b to facilitate the threaded connections 70 of drill pipe 50 to adjacent drill pipe(s) 50 within drillstring 30 as previously described. In particular, a female or box threaded connector 80 (or more simply a “box” or “box end”) is disposed at upper end 50a and a male or pin threaded connector 60 (or more simply a “pin” or “pin end”) disposed at lower end 50b. As will be described in more detail below, box 80 includes a plurality of internal threads that threadably mate and engage the external threads of a pin connector (e.g., pin 60) of an axially adjacent drill pipe 50 (e.g., with respect to axis 31) to form a threaded connection 70, and pin 60 includes a plurality of external threads that are configured to threadably mate and engage with the internal threads of a box threaded connector (e.g., box 80) of an axially adjacent drill pipe 50 (e.g., with respect to axis 31) to form a threaded connection 70. Further details of pin 60, box 80, and threaded connection 70 will be described in more detail below.

Referring still to FIGS. 2 and 3, in this embodiment, drill pipe 50 also includes a pair of upsets each extending axially from one of the threaded connectors 60, 80 to a central tubular region 58. As used herein, the term “upset” generally refers to an increase in the cross-sectional area of joint 50 relative to the cross-section area within central tubular region 58. In particular, in this embodiment, joint 50 includes a first or upper upset 54 extending axially between box 80 and central tubular region 58 and a second or lower upset 56 extending axially between pin 60 and central tubular region 58. Each upset 54, 56 includes an expanded cross-sectional area such that radially outer surface 50c is expanded radially outward from axis 55 at upsets 54, 56 relative to region 58 and radially inner surface 50d is expanded radially inward toward axis 55 at upsets 54, 56 relative to region 58. However, it should be appreciated that in other embodiments, upsets 54, 56 include a radial expansion along only one of the surfaces 50c, 50d, and in still other embodiments, no upsets 54, 56 are included on joint 50 while still complying with the principles disclosed herein.

As shown in FIGS. 2 and 3, drill pipe 50 is assembled by forming upsets 54, 56 at the axial ends of region 58. Thereafter, threaded connectors 60, 80 are secured to upsets 56, 54, respectively, by any suitable method (e.g., welding, integral formation, etc.). In addition, upsets 54, 56 may be formed on tubular region 58 by any suitable method while still complying with the principles disclosed herein. For example, in some embodiments, upsets 54, 56 are formed by heating the axial ends of tubular region 58, and impacting each heated end along axis 55, thereby forcing surface 50c, 50d to radially expand in the manner described above (and shown).

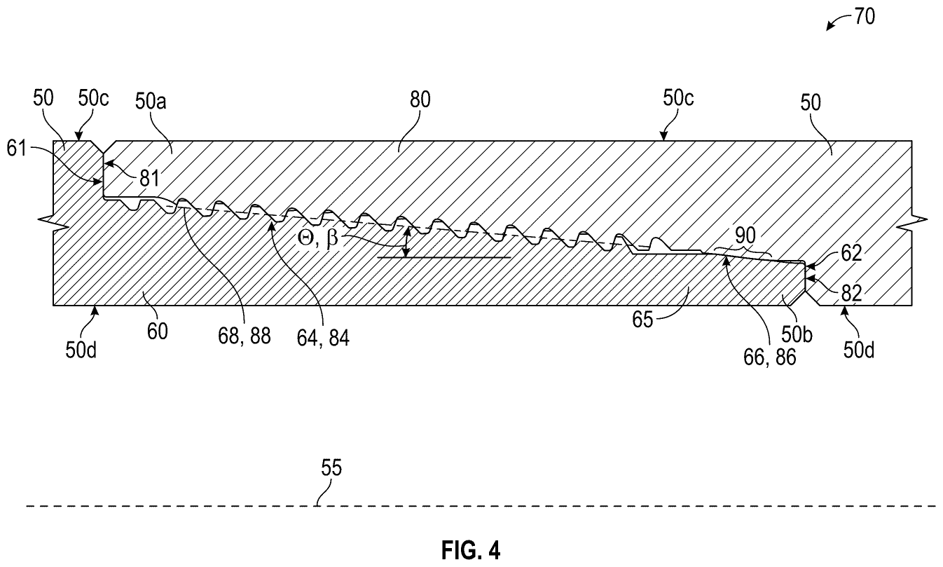

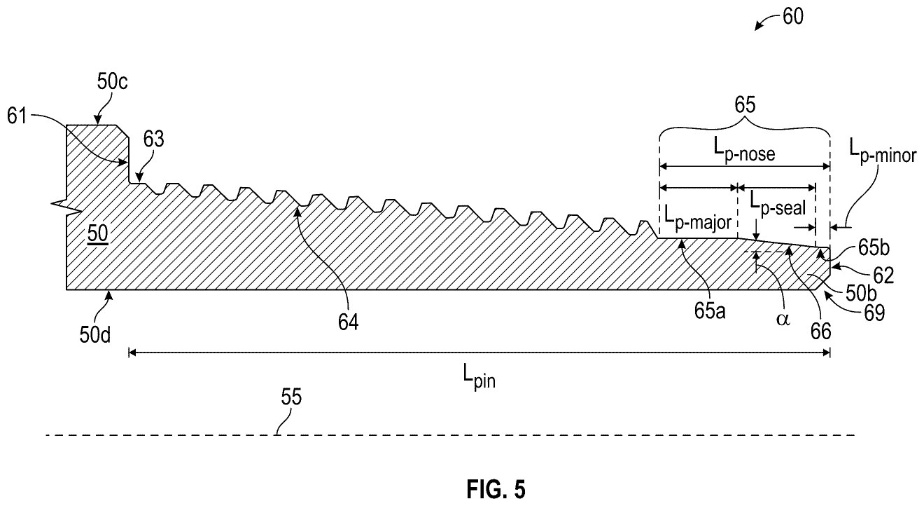

Referring now to FIGS. 4 and 5, pin threaded connector 60 includes a primary or external annular shoulder 61 that extends radially inward from radially outer surface 50c and a secondary or internal annular shoulder 62 that extends radially outward from radially inner surface 50d at lower end 50b. Shoulders 61, 62 are axially spaced from each other relative to axis 55. In this embodiment, each shoulder 61, 62 comprises and is defined by annular planar surface disposed in a plane oriented perpendicular to central axis 55. As will be described in more detail below, shoulders 61, 62 are configured to engage with corresponding shoulders in a box threaded connector (e.g., shoulders 81, 82, respectively on box 80) on a mating drill pipe 50. Although shoulders 61, 62 are defined by planar surfaces disposed in planes oriented perpendicular to central axis 55 in this embodiment, in other embodiments, one or both of the shoulders (e.g., shoulders 61, 62) may comprise and be defined by sloped or frustoconical surface(es) that are not disposed in plane(s) oriented perpendicular to the central axis (e.g., axis 55).

Moving axially along pin 60 (along outer surface 50c) from primary shoulder 61 to secondary shoulder 62, pin 60 includes a transition surface 63 extending axially from primary shoulder 61, external threads 64 extending axially from transition surface 63, and a pin nose 65 extending axially from external threads 64 to secondary shoulder 62. Pin nose 65 has several discrete axial sections or portions including a major pin nose section 65a extending axially from external threads 64, a pin seal surface 66 extending axially from major pin nose section 65a, and a minor pin nose section 65b extending axially from pin seal surface 66 to secondary shoulder 62. Thus, major pin nose section 65a is axially positioned between external threads 64 and pin seal surface 66, pin seal surface 66 is axially positioned between major pin nose section 65a and minor pin nose section 65b, and minor pin nose section 65b is axially positioned between pin seal surface 66 and secondary shoulder 62.

External threads 64 on pin 60 are formed along a line of taper 68 that is angled relative to axis 55 at an angle θ. In this embodiment, external threads 64 preferably taper from approximately 0.75 to 3.0 inches of diameter per foot of axial length (“inches per foot” or “in/ft”) (i.e., the angle θ ranges from approximately 1.79° to 7.13°), more preferably taper from approximately 1.5 to 2.5 in/ft (i.e., the angle θ more preferably ranges from approximately 3.58° to 5.95°), and still more preferably taper at 2.0 in/ft (i.e., the angle θ still more preferably approximately equals 4.76°). However, it should be appreciated that other values are possible for the taper and the angle θ while still complying with the principles disclosed herein.

In this embodiment, transition surface 63 is defined by an annular cylindrical surface extending axially from primary shoulder 61 to external threads 64, major pin nose section 65a is defined by an annular cylindrical surface extending axially from external threads 64 to pin seal surface 66, pin seal surface 66 is defined by an annular frustoconical surface that extends axially from major pin nose section 65a to minor pin nose section 65b, and minor pin nose section 65b is defined by an annular cylindrical surface extending axially from tapered pin seal surface 66 to secondary shoulder 62. In other embodiments, the transition surface (e.g., transition surface 63), the major pin nose section (e.g., major pin nose section 65a), the minor pin nose section (e.g., minor pin nose section 65b), or combinations thereof may be defined by non-cylindrical annular surfaces such as tapered or frustoconical surfaces.

As noted above, pin seal surface 66 is defined by an annular frustoconical surface in this embodiment, and thus, may also be referred to as a tapered pin seal surface 66. However, as will be described in more detail below, in other embodiments, the pin seal surface (e.g., pin seal surface 66) may be defined by an annular convex cylindrical surface that extends axially from the major pin nose section (e.g., major pin nose section 65a) to the minor pin nose section (e.g., minor pin nose section 65b).

Tapered pin seal surface 66 slopes radially inward as it extends axially from major pin nose section 65a to minor pin nose section 65b. In particular, tapered pin seal surface 66 is disposed at a taper angle a relative to central axis 55. Due to the slope of tapered pin seal surface 66, the cylindrical surface defining major pin nose section 65a is disposed at a radius (relative to central axis 55) that is greater than the radius (relative to central axis 55) of the cylindrical surface defining minor pin nose section 65b. An annular bevel or chamfer 69 extends from radially inner surface 50d to secondary shoulder 62. In general, chamfer 69 can be disposed at an angle relative to central axis 55 that ranges from 25° to 65°. In this embodiment, chamfer 69 is disposed at an 45° angle relative to central axis 55. Although chamfer 69 is provided at secondary shoulder 62 to remove material therefrom in this embodiment, in other embodiments, different features can be provided to remove material from the secondary shoulder (e.g., shoulder 62).

As best shown in FIG. 5, pin threaded connector 60 has a connection length Lₚᵢₙ measured axially from primary shoulder 61 to secondary shoulder 62, pin nose 65 has a length Lₚ₋ₙₒₛₑ measured axially from external threads 64 to secondary shoulder 62, major pin nose section 65a has a length Lₚ₋ₘₐⱼₒᵣ measured axially from external threads 64 to tapered pin seal surface 66 (i.e., the axial length of the cylindrical surface defining major pin nose section 65a), tapered pin seal surface 66 has a length Lₚ₋ₛₑₐₗ measured axially from major pin nose section 65a to minor pin nose section 65b (i.e., the axial length of the frustoconical surface defining tapered pin seal surface 66), and minor pin nose section 65b has a length Lₚ₋ₘᵢₙₒᵣ measured axially from tapered pin seal surface 66 to secondary shoulder 62 (i.e., the axial length of the cylindrical surface defining minor pin nose section 65b). Based on the foregoing, it is to be understood that the length Lₚ₋ₙₒₛₑ is equal to the sum of length Lₚ₋ₘₐⱼₒᵣ, Lₚ₋ₛₑₐₗ, and Lₚ₋ₘᵢₙₒᵣ as shown in equation 1 below.

$${L}_{p - nose} = {L}_{p - major} + {L}_{p - seal} + {L}_{p - minor}$$

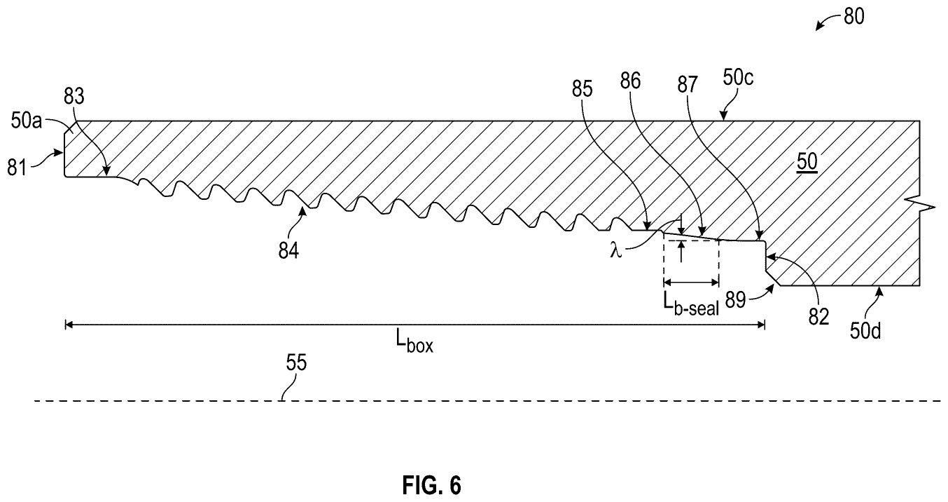

Referring now to FIGS. 4 and 6, box threaded connector 80 of drill pipe 50 threadingly engages and seals with a pin threaded connector 60 of an adjacent drill pipe 50 to form a threaded connection 70, and thus, box threaded connector 80 generally includes features that correspond and mate with the features of pin threaded connector 60 previously described. In particular, box threaded connector 80 includes a primary or external annular shoulder 81 that extends radially inward from radially outer surface 50c at upper end 50a and a secondary or internal annular shoulder 82 that extends radially outward from radially inner surface 50d. Shoulders 81, 82 are axially spaced from each other relative to axis 55. As will be described in more detail below, shoulders 81, 82 are configured to axially abut, mate, and engage with corresponding shoulders 61, 62, respectively, of pin threaded connector 60 on the adjacent, mating drill pipe 50. Accordingly, in this embodiment, each shoulder 81, 82 comprises and is defined by annular planar surface disposed in a plane oriented perpendicular to central axis 55. However, in other embodiments where one or both of the pin connector shoulders (e.g., shoulders 61, 62) comprise and be defined by sloped or frustoconical surface(es) that are not disposed in plane(s) oriented perpendicular to the central axis (e.g., axis 55), the corresponding box connector shoulders (e.g., shoulders 81, 82) comprise and be defined by mating surfaces (e.g., sloped or frustoconical surface(es) that are not disposed in plane(s) oriented perpendicular to the central axis (e.g., axis 55)).

Moving axially along box 80 (along outer surface 50c) from primary shoulder 81 to secondary shoulder 82, box 80 includes a first transition surface 83 extending axially from primary shoulder 81, internal threads 84 extending axially from first transition surface 83, a second transition surface 85 extending axially from internal threads 84, a box seal surface 86 extending axially from second transition surface 85, and a third transition surface 87 extending axially from box seal surface 86 to secondary shoulder 82.

Internal threads 84 on box 80 are formed along a line of taper 88 that is angled relative to axis 55 at an angle β. Internal threads 84 on box 80 are designed to mate and threadably engage external threads 64 on pin 60. In this embodiment, the angle β is the same as the angle θ previously described. However, in other embodiments, the angles θ, β may be different while still allowing mating, non-interfering engagement as described in more detail below.

In this embodiment, first transition surface 83 is defined by an annular cylindrical surface extending axially from primary shoulder 81 to internal threads 84, second transition surface 85 is defined by an annular cylindrical surface extending axially from internal threads 84 to box seal surface 86, box seal surface 86 is defined by an annular frustoconical surface extending axially from second transition surface 85 to third transition surface 87, and third transition surface 87 is defined by an annular cylindrical surface extending axially from box seal surface 86 to secondary shoulder 82. In other embodiments, the first transition surface (e.g., first transition surface 83), the second transition surface (e.g., second transition surface 85), the third transition surface (e.g., third transition surface 87), or combinations thereof may be defined by non-cylindrical surfaces such as tapered or frustoconical surfaces.

As noted above, box seal surface 86 is defined by an annular frustoconical surface in this embodiment, and thus, may also be referred to as a tapered box seal surface 86. However, in other embodiments, the box seal surface (e.g., box seal surface 86) may be defined by an annular convex cylindrical surface that extends axially from the second transition surface (e.g., second transition surface 85) to the third transition surface (e.g., third transition surface 87).

Tapered box seal surface 86 slopes radially inward as it extends axially from second transition surface 85 to third transition surface 87. In particular, tapered box seal surface 86 is disposed at a taper angle λ relative to central axis 55. In this embodiment of threaded connection 70, tapered box seal surface 86 and tapered pin seal surface 66 mate and slidingly engage to form a metal-to-metal seal 90 when threaded connection 70 is made up (FIG. 4). More specifically, in this embodiment, taper angle λ of tapered box seal surface 84 is the same as taper angle a of tapered pin seal surface 66. However, in other embodiments, the taper angles α, λ may vary by up to 1° to 3°, or alternatively, vary by up to 2°. Due to the slope of tapered box seal surface 84, third transition surface 87 is disposed at a radius (relative to central axis 55) that is less than the radius (relative to central axis 55) of second transition surface 85.

An annular bevel or chamfer 89 extends from radially inner surface 50d to secondary shoulder 82. In general, chamfer 89 can be disposed at an angle relative to central axis 55 that ranges from 25° to 65°. In this embodiment, chamfer 89 is disposed at an 45° angle relative to central axis 55. Although chamfer 89 is provided at secondary shoulder 82 to remove material therefrom in this embodiment, in other embodiments, different features can be provided to remove material from the secondary shoulder (e.g., shoulder 82).

As best shown in FIG. 4, first cylindrical surface 83 is disposed at a radius (relative to central axis 55) that is greater than the radius of minor pin nose section 65b, and second cylindrical surface 85 is disposed at a radius (relative to central axis 55) that is greater than the radius of major pin nose section 65a.

As best shown in FIG. 6, box threaded connector 80 has a connection length L_{box} measured axially from primary shoulder 81 to secondary shoulder 82 and tapered box seal surface 84 has a length L_{b-seal} measured axially from first cylindrical surface 83 to second cylindrical surface 85. In this embodiment, connection lengths Lₚᵢₙ, L_{box} are the same, and the length L_{b-seal} is less than or equal to Lₚ₋ₛₑₐₗ. However, in other embodiments, the length L_{b-seal} is equal to or greater than the length Lₚ₋ₛₑₐₗ.

Referring now to FIG. 4, pin 60 and box 80 are coupled via threading of mating threads 64, 84 to makeup threaded connection 70, and pin 60 and box 80 are decoupled via unthreading of mating threads 64, 84 to break threaded connection 70. In general, pin 60 and/or box 80 (and the corresponding drill pipes 50) can be rotated to make and break threaded connection 70. Pin 60 and box 80 are designed and sized such that primary shoulder 61 of pin 60 and primary shoulder 81 of box 80 mate and slidingly engage when threaded connection 70 is madeup, secondary shoulder 62 of pin 60 and secondary shoulder 82 of box 80 mate and slidingly engage when threaded connection 70 is madeup, and tapered seal surfaces 66, 86 mate and slidingly engage when threaded connection 70 is madeup. More specifically, during makeup, pin 60 is threaded into box 80 (by rotating pin 60 and/or box 80) until the slidingly contact of shoulders 61, 81, shoulders 62, 82, and seal surfaces 66, 86. In some embodiments, primary shoulders 61, 81 will contact just before secondary shoulders 62, 82 and/or seal surfaces 66,86. Additional torque is applied to threaded connection 70 after the initial contact of shoulders 61, 81, shoulders 62, 82, and seal surfaces 66, 86 to axially compress shoulders 61, 81 together, axially compress shoulders 62, 82 together, and radially compress seal surfaces 66, 86 together to form metal-to-metal seal 90. Accordingly, metal-to-metal seal 90 may also be described as a “radial” seal. In embodiments described herein, threads 64, 84 are “free running” or “non-interference” threads, which means threads 64, 84 are designed and have nominal dimensions such that there is no interference of opposed flanks of threads 64, 84 or opposed crests and roots of threads 64, 84 during makeup of threaded connection 70 up to the initial contact of shoulders 61, 81. The additional torque applied subsequent to the initial contact of shoulders 61, 81, shoulders 62, 82, and seal surfaces 66, 86 may induce interference of threads 64, 84, as well as apply sufficient compression to tapered seal surfaces 66, 84 to form metal-to-metal seal 90. When threaded connection 70 is made up, third transition surface 87 radially opposes or faces minor pin nose section 65b and/or a portion of tapered pin seal surface 66 but is radially spaced therefrom, second transition surface 85 radially opposes or faces major pin nose 65a and/or a portion of tapered pin seal surface 66 but is radially spaced therefrom, and first transition surface 83 radially opposes or faces transition surface 63 and/or a portion of external threads 64 but is radially spaced therefrom. In addition, when threaded connection 70 is made up, the planar surfaces defining shoulders 61, 82 are axially compressed into flush engagement, and the planar surfaces defining shoulders 62, 81 are axially compressed into flush engagement.

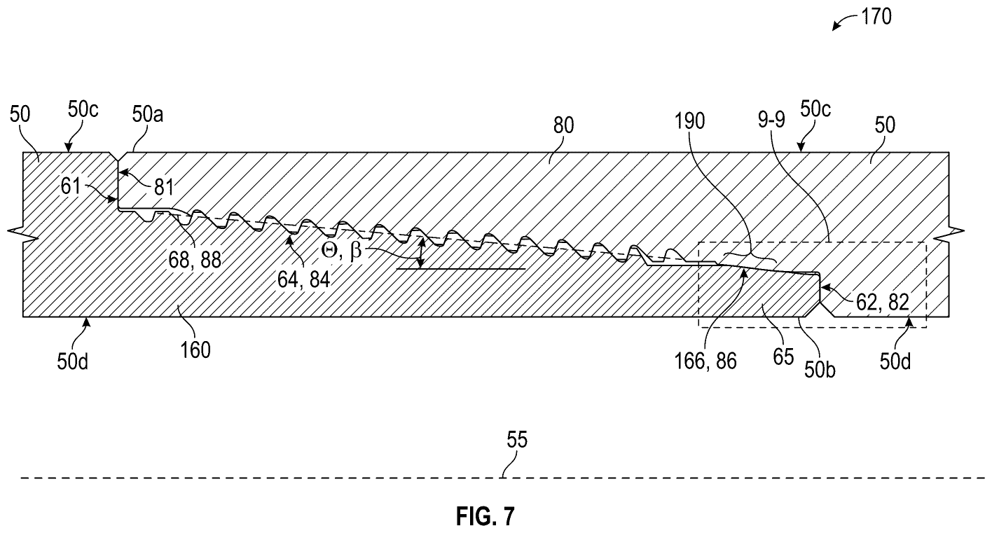

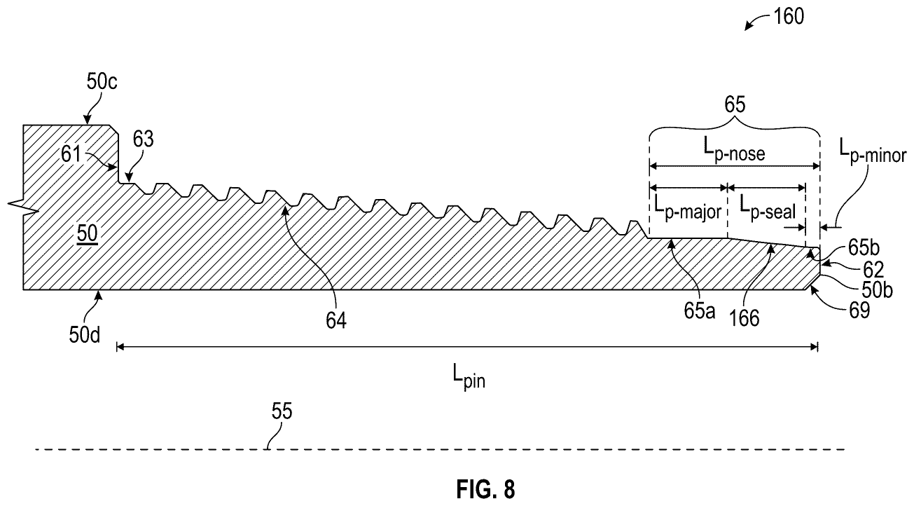

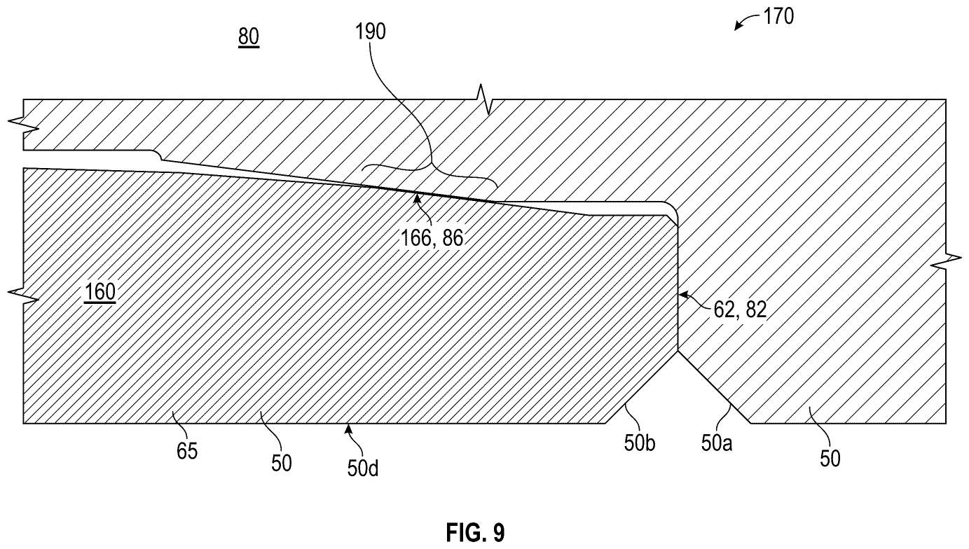

As noted above, in the embodiment of threaded connection 70 described above, both the pin seal surface 66 and box seal surface 86 are defined annular frustoconical surfaces. However, in other embodiments, the pin seal surface (e.g., pin seal surface 66) and/or the box seal surface (e.g., box seal surface 86) may be defined by an annular convex cylindrical surface. For example, referring now to FIG. 7, an embodiment of a threaded connection 170 that includes an annular convex cylindrical pin seal surface is shown. Threaded connection 170 is substantially the same as threaded connection 70 previously described. In particular, threaded connection 170 includes a threaded pin connector 160 disposed at an end 50b of a tubular member 50 and a threaded box connector 80 disposed at an end 50a of an adjacent tubular member 50. Box connector 80 is as previously described and shown. As best shown in FIGS. 8 and 9, pin connector 160 is substantially the same as pin connector 60 previously described with the exception that tapered pin seal surface 66 is replaced with an annular convex cylindrical seal surface 166. Convex cylindrical seal surface 166 is generally cylindrical in a cross-section taken in any plane containing central axis 55. Seal surface 166 of pin connector 160 slidingly engages seal surface 86 of box connector 80 to form annular metal-to-metal seal 190. The geometry and operation (makeup and breakout) of threaded connector 170 is generally the same as the geometry and operation of threaded connector 70 previously described. Similar embodiments are also possible where the seal surface 86 on the box connection 80 is replaced by a concave cylindrical seal surface to form an annular metal-to-metal seal and the pin member can be a frustoconical member 66 as shown in FIG. 5 or a convex cylindrical seal surface 166 as shown in FIG. 9.

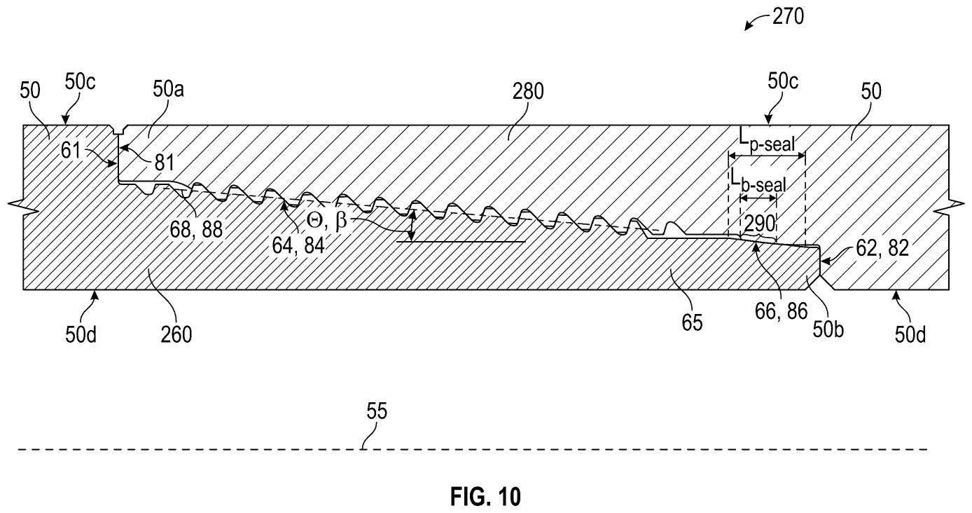

As previously described, mating seal surfaces 66, 86 slidingly engage when threaded connection 70 is madeup to form metal-to-metal seal 90. Thus, the mating seal surfaces that slidingly engage to form the metal-to-metal seal (e.g., seal surfaces 66, 86 that slidingly engage to form metal-to-metal seal 90) must necessarily axially overlap when the threaded connection (e.g., threaded connection 70) is madeup. Notwithstanding the foregoing, the relative axial positions of mating seal surfaces may vary. For example, as shown in FIG. 4, box seal surface 86 extends axially closer to primary shoulders 61, 81 (to the left in FIG. 4) than pin seal surface 66, whereas pin seal surface 66 extends axially closer to secondary shoulders 62, 82 (to the right in FIG. 4) than box seal surface 86. In yet other embodiments, the box seal (e.g., box seal surface 86) may extend axially closer to the primary shoulders (e.g., primary shoulders 61, 81) than the pin seal surface (e.g., pin seal surface 66) and the pin seal surface (e.g., pin seal surface 66) may extend axially closer to the secondary shoulders (e.g., secondary shoulders 62, 82) than the box seal surface (e.g., box seal surface 86); the pin seal surface may be completely axially positioned between the axial ends of the box seal surface; or the box seal surface may be completely axially positioned between the axial ends of the pin seal surface. For example, referring now to FIG. 10, an embodiment of a threaded connection 270 is shown. Threaded connection 270 is substantially the same as threaded connection 70 previously described. In particular, threaded connection 270 includes a threaded pin connector 260 disposed at an end 50b of a tubular member 50 and a threaded box connector 280 disposed at an end 50a of an adjacent tubular member 50. Pin connector 260 is substantially the same as pin connector 60 previously described and box connector 280 is substantially the same as box connector 80 previously described with the exception that the relative lengths Lₚ₋ₛₑₐₗ, L_{b-seal} of pin seal surface 66 and box seal surface 86, respectively, are varied such that box seal surface 86 is completely axially positioned within pin seal surface 66 when threaded connection 270 is madeup and seal surfaces 66, 86 slidingly engage to form an annular metal-to-metal seal 290 therebetween. In particular, pin seal surface 66 engages the entirety of box seal surface 86 with pin seal surface 66 extending axially beyond both axial ends of box seal surface 86-pin seal surface 66 extends axially closer to primary shoulders 61, 81 than box seal surface 86 and pin seal surface 66 extends axially closer to secondary shoulders 62, 82 than box seal surface 86 when threaded connection 270 is madeup to form annular metal-to-metal seal 290. Thus, in this embodiment, the length Lb-seal of box seal surface 88 is less than the length Lp-seal of pin seal surface 68. The geometry and operation (makeup and breakout) of threaded connector 270 is generally the same as the geometry and operation of threaded connector 70 previously described.

Embodiments described herein are designed and configured to offer the potential for improved pressure sealing at metal-to-metal seal 90 and enhanced robustness of metal-to-metal seal 90 (e.g., enhanced anti-galling and durability despite repeated makeup and breakout cycles of threaded connections 70). In particular, the geometries of pin 60 and box 80 were adjusted and modified through a variety of analyses including numerical simulations to enhance the robustness of metal-to-metal seal 90 (the number of make and break cycles without damage to seal 90) while retaining the ability to seal against internal pressures (e.g., upwards of 20,000 psi) at metal-to-metal seal 90.

The analyses considered local contact stresses that arise at metal-to-metal seals in threaded connections in response to applying preload (i.e., make-up torque). Even at makeup, such local contact stresses at metal-to-metal seals can exceed the specified minimum yield strength of the materials forming the metal-to-metal seals. Performing multiple makes and breaks with such surfaces having local yielding can lead to scoring and galling at the metal-to-metal seal, which may be sufficient to undesirably cause damage and require repair. Also such damage on the metal-to-metal seal surfaces can adversely impact the sealing ability to successfully withstand the applied internal pressure. Thus, without being limited by this or any particular theory, a balance and distribution of the contact stresses due to preload makeup torque at the metal-to-metal seals is particularly beneficial to allow for multiple make and breaks (i.e., enhanced robustness). The analyses also considered that (i) the application of internal pressure to a madeup threaded connection provides a self-energizing effect to metal-to-metal seals due to the induced hoop stress component, which aids in the seal-ability of the metal-to-metal seals against applied loads; and (ii) application of external axial tensile loads reduces the contact pressure at metal-to-metal seals of threaded connections, and thus, adversely affects the sealability.

Taking into account the foregoing, embodiments described herein include several structural features that offer the potential to improve pressure sealing at metal-to-metal seal 90 and enhance robustness of metal-to-metal seal 90 (e.g., enhanced anti-galling and durability despite repeated makeup and breakout cycles of threaded connections 70, 170). Those features include (i) a relatively large or extended length Lₚ₋ₘₐⱼₒᵣ of major pin nose section 65a to axially space metal-to-metal seal 90, 190 from threads 64, 84 and protect against unloading of metal-to-metal seal 90, 190 under tensile loads and thread interference at makeup; (ii) a tapered pin seal surface 66 having a relatively large length Lₚ₋ₛₑₐₗ to distribute the preload torque along a larger contact surface area of metal-to-metal seal 90, 190 to reduce local contact stresses; (iii) a minor pin nose section 65b having a relatively short length Lₚ₋ₘᵢₙₒᵣ to move metal-to-metal seal 90, 190 axially closer to secondary shoulder 62 and provide added resistance against applied internal pressure; (iv) a tapered pin seal surface 66 oriented at a relatively shallow or flat taper angle α to reduce the propensity of metal-to-metal seal 90 to unload under axial tensile loads; and (v) inclusion of features to lower the stiffness of pin 60 (e.g., chamfer 69) and reduce the makeup torque for threaded connection 70, 170 and aid in balancing the preload distribution of loads along metal-to-metal seal 90, 190. The foregoing structural features can be quantified via several metrics as follows:

$$Ratio of {L}_{p - nose} to {L}_{p i n} = \frac{{L}_{p - nose}}{{L}_{p i n}} = \frac{( {L}_{p - major} + {L}_{p - minor} + {L}_{p - seal} )}{{L}_{p i n}}$$

$${L}_{p - nose} = {L}_{p - major} + {L}_{p - minor} + {L}_{p - seal}$$

$$Ratio of {L}_{p - major} to {L}_{p - nose} = \frac{{L}_{p - major}}{{L}_{p - nose}} = \frac{{L}_{p - major}}{( {L}_{p - major} + {L}_{p - minor} + {L}_{p - seal} )}$$

$${L}_{p - seal} taper angle α of tapered pin seal surface 66$$

$$Ratio of {L}_{p - minor} {L}_{p - major} = \frac{{L}_{p - minor}}{{L}_{p - major}}$$

To offer the potential to improve pressure sealing at metal-to-metal seal 90 and enhance robustness of metal-to-metal seal 90 (e.g., enhanced anti-galling and durability despite repeated makeup and breaking of threaded connections 70), embodiments described herein preferably exhibit the following for the foregoing metrics:
Ratio of Lₚ₋ₙₒₛₑ to Lₚᵢₙ≥0.10, alternatively ranges from 0.10 to 0.40, and alternatively ranges from 0.20 to 0.30;
Lₚ₋ₙₒₛₑ≥1.625 in., alternatively ranges from 1.625 inch to 3.000 inch, and alternatively ranges from 1.750 inch to 2.750 inch;
Ratio of Lₚ₋ₘₐⱼₒᵣ to Lₚ₋ₙₒₛₑ≥0.25, alternatively ranges from 0.25 to 0.75, and alternatively ranges from 0.30 to 0.60;
Lₚ₋ₛₑₐₗ≥0.625 in., alternatively ranges from 0.625 inch to 2.000 inch, and alternatively ranges from 0.750 inch to 1.500 inch;
4°≤taper angle α≤12°, and alternatively 5°≤taper angle α≤10°; and
0.10≤Ratio of Lₚ₋ₘᵢₙₒᵣ to Lₚ₋ₘₐⱼₒᵣ≤0.50, and alternatively 0.10≤Ratio of Lₚ₋ₘᵢₙₒᵣ to Lₚ₋ₘₐⱼₒᵣ≤0.30.

In the manner described, a threaded connection in accordance with the principles disclosed herein (e.g., connection 70, 170) is formed that includes a metal-to-metal seal (e.g., metal-to-metal seal 90, 190) having improved pressure sealing capabilities and enhanced robustness (e.g., enhanced anti-galling and durability despite repeated makeup and break cycles of threaded connections 70, 170). While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of this disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A threaded connection between an end of a first tubular member having a central axis and an end of a second tubular member having a central axis coaxially aligned with the central axis of the first tubular member, wherein the threaded connection comprises:
a threaded box connector disposed at the end of the first tubular member, wherein the threaded box connector comprises:
a box external shoulder;
a box internal shoulder axially spaced from the box external shoulder;
a plurality of internal threads axially positioned between the box external shoulder and the box internal shoulder; and
a box seal surface axially positioned between the internal threads and the box internal shoulder;
a threaded pin connector disposed at the end of the second tubular member and threadably coupled to the threaded box connector, wherein the threaded pin connector comprises:
a pin external shoulder that engages the box external shoulder;
a pin internal shoulder axially spaced from the pin external shoulder, wherein the pin internal shoulder engages the box internal shoulder;
a plurality of external threads axially positioned between the pin external shoulder and the pin internal shoulder, wherein the external threads of the threaded pin connector mate with and threadably engage the internal threads of the threaded box connector; and
a pin nose extending axially from the plurality of external threads to the pin internal shoulder, wherein the pin nose includes a pin seal surface that sealingly engages the box seal surface and a major pin nose section extending axially from the external threads to the pin seal surface;
wherein the pin nose has a length Lp-nose measured axially from the plurality of external threads to the pin internal shoulder, wherein the length Lp-nose is greater than or equal to 1.625 in.

2. The threaded connection of claim 1, wherein the major pin nose section has a length Lp-major measured axially from the external threads to the pin seal surface, wherein the ratio of the length Lp-major to the length Lp-nose is greater than or equal to 0.25.

3. The threaded connection of 1, wherein the length Lp-nose is greater than or equal to 1.625 in. and less than or equal to 3.000 in., and wherein the ratio of the length Lp-major to the length Lp-nose is greater than or equal to 0.25 and less than or equal to 0.75.

4. The threaded connection of 3, wherein the length Lp-nose is greater than or equal to 1.750 in. and less than or equal to 2.750 in., and wherein the ratio of the length Lp-major to the length Lp-nose is greater than or equal to 0.30 and less than or equal to 0.60.

5. The threaded connection of claim 1, wherein the threaded pin connector has a length Lpin measured axially from the pin external shoulder to the pin internal shoulder, wherein the ratio of the length Lp-nose to the length Lpin is greater than or equal to 0.10.

6. The threaded connection of claim 5, wherein the ratio of the length Lp-nose to the length Lpin is greater than or equal to 0.10 and less than or equal to 0.40.

7. The threaded connection of claim 1, wherein the pin nose includes a minor pin nose section extending axially from the pin seal surface to the pin internal shoulder, wherein the pin seal surface has a length Lp-seal measured axially from the major pin nose section to the minor pin nose section, and wherein the length Lp-seal is greater than or equal to 0.625 in.

8. The threaded connection of claim 7, wherein the length Lp-seal is greater than or equal to 0.625 in. and less than or equal to 2.000 in.

9. The threaded connection of claim 1, wherein the pin nose includes a minor pin nose section extending axially from the pin seal surface to the pin internal shoulder;
wherein the major pin nose section is defined by a first cylindrical surface, the pin seal surface is defined by a frustoconical surface, and the minor pin nose section is defined by a second cylindrical surface;
wherein the pin seal surface slopes radially inwardly moving axially from the major pin nose section to the minor pin nose section.

10. The threaded connection of claim 1, wherein the pin seal surface is defined by a frustoconical surface oriented at a taper angle a relative to the central axis of the second tubular member, wherein the taper angle a ranges from 4° to 12°.

11. A threaded connection between an end of a first tubular member having a central axis and an end of a second tubular member having a central axis coaxially aligned with the central axis of the first tubular member, wherein the threaded connection comprises:
a threaded box connector disposed at the end of the first tubular member, wherein the threaded box connector comprises:
a box external shoulder;
a box internal shoulder axially spaced from the box external shoulder;
a plurality of internal threads axially positioned between the box external shoulder and the box internal shoulder; and
a box seal surface axially positioned between the internal threads and the box internal shoulder;
a threaded pin connector disposed at the end of the second tubular member and threadably coupled to the threaded box connector, wherein the threaded pin connector comprises:
a pin external shoulder that engages the box external shoulder;
a pin internal shoulder axially spaced from the pin external shoulder, wherein the pin internal shoulder engages the box internal shoulder;
a plurality of external threads axially positioned between the pin external shoulder and the pin internal shoulder, wherein the external threads of the threaded pin connector mate with and threadably engage the internal threads of the threaded box connector; and
a pin nose extending axially from the plurality of external threads to the pin internal shoulder, wherein the pin nose includes a pin seal surface that sealingly engages the box seal surface, a major pin nose section extending axially from the external threads to the pin seal surface, and a minor pin nose section extending axially from the pin seal surface to the pin internal shoulder;
wherein the pin nose has a length Lp-nose measured axially from the plurality of external threads to the pin internal shoulder;
wherein the major pin nose section has a length Lp-major measured axially from the external threads to the pin seal surface;
wherein the ratio of the length Lp-major to the length Lp-nose is greater than or equal to 0.25.

12. The threaded connection of claim 11, wherein the threaded pin connector has a length Lpin measured axially from the pin external shoulder to the pin internal shoulder;
wherein the pin seal surface has a length Lp-seal measured axially from the major pin nose section to the minor pin nose section;
wherein the pin seal surface is defined by a frustoconical surface oriented at a taper angle a relative to the central axis of the second tubular member;
wherein the ratio of the length Lp-nose to the length Lpin is greater than or equal to 0.10;
wherein the length Lp-nose is greater than or equal to 1.625 in.;
wherein the length Lp-seal is greater than or equal to 0.625 in.;
wherein the taper angle α ranges from 4° to 12°.

13. The threaded connection of 12, wherein the ratio of the length Lp-nose to the length Lpin is greater than or equal to 0.10 and less than or equal to 0.40;
wherein the length Lp-nose is greater than or equal to 1.625 in. and less than or equal to 3.000 in.;
wherein the ratio of the length Lp-major to the length Lp-nose is greater than or equal to 0.25 and less than or equal to 0.75;
wherein the length Lp-seal is greater than or equal to 0.625 in. and less than or equal to 2.000 in.;
wherein the taper angle α ranges from 5° to 10°.

14. The threaded connection of 13, wherein the ratio of the length Lp-nose to the length Lpin is greater than or equal to 0.10 and less than or equal to 0.30;
wherein the length Lp-nose is greater than or equal to 1.750 in. and less than or equal to 2.750 in.;
wherein the ratio of the length Lp-major to the length Lp-nose is greater than or equal to 0.30 and less than or equal to 0.60; and
wherein the length Lp-seal is greater than or equal to 0.750 in. and less than or equal to 1.500 in.

15. The threaded connection of 12, wherein the minor pin nose section has a length Lp-minor measured axially from the pin seal surface to the pin internal shoulder, wherein the ratio of the length Lp-minor to the length Lp-major is greater than or equal to 0.10 and less than or equal to 0.50.

16. The threaded connection of claim 15, wherein the ratio of the length Lp-minor to the length Lp-major is greater than or equal to 0.10 and less than or equal to 0.30.

17. A threaded connection between an end of a first tubular member having a central axis and an end of a second tubular member having a central axis coaxially aligned with the central axis of the first tubular member, wherein the threaded connection comprises:
a threaded box connector disposed at the end of the first tubular member, wherein the threaded box connector comprises:
a box external shoulder;
a box internal shoulder axially spaced from the box external shoulder;
a plurality of internal threads axially positioned between the box external shoulder and the box internal shoulder; and
a box seal surface axially positioned between the internal threads and the box internal shoulder;
a threaded pin connector disposed at the end of the second tubular member and threadably coupled to the threaded box connector, wherein the threaded pin connector comprises:
a pin external shoulder that engages the box external shoulder;
a pin internal shoulder axially spaced from the pin external shoulder, wherein the pin internal shoulder engages the box internal shoulder;
a plurality of external threads axially positioned between the pin external shoulder and the pin internal shoulder, wherein the external threads of the threaded pin connector mate with and threadably engage the internal threads of the threaded box connector; and
a pin nose extending axially from the plurality of external threads to the pin internal shoulder, wherein the pin nose includes a pin seal surface that sealingly engages the box seal surface, a major pin nose section extending axially from the external threads to the pin seal surface, and a minor pin nose section extending axially from the pin seal surface to the pin internal shoulder;
wherein the major pin nose section has a length Lp-major measured axially from the external threads to the pin seal surface;
wherein the minor pin nose section has a length Lp-minor measured axially from the pin seal surface to the pin internal shoulder
wherein the ratio of the length Lp-minor to the length Lp-major is greater than or equal to 0.10 and less than or equal to 0.50.

18. The threaded connection of claim 17, wherein the pin seal surface is defined by a frustoconical surface oriented at a taper angle a relative to the central axis of the second tubular member, wherein the taper angle a ranges from 5° to 10°.

19. The threaded connection of claim 17, wherein the box seal surface is defined by a frustoconical surface oriented at a taper angle λ relative to the central axis of the first tubular member, wherein the taper angle λ is the same as the taper angle α.

20. The threaded connection of claim 17, wherein the threaded pin connector has a length Lpin measured axially from the pin external shoulder to the pin internal shoulder;
wherein the pin nose has a length Lp-nose measured axially from the plurality of external threads to the pin internal shoulder;
wherein the ratio of the length Lp-nose to the length Lpin is greater than or equal to 0.10.

21. The threaded connection of claim 20, wherein the ratio of the length Lp-nose to the length Lpin is greater than or equal to 0.10 and less than or equal to 0.30.

22. The threaded connection of claim 17, wherein the pin seal surface has a length Lp-seal measured axially from the major pin nose section to the minor pin nose section;
wherein the length Lp-seal is greater than or equal to 0.625 in.

23. The threaded connection of claim 22, wherein the length Lp-seal is greater than or equal to 0.750 in. and less than or equal to 1.500 in.

24. The threaded connection of claim 17, wherein the ratio of the length Lp-minor to the length Lp-major is greater than or equal to 0.10 and less than or equal to 0.30

25. A threaded connection between an end of a first tubular member having a central axis and an end of a second tubular member having a central axis coaxially aligned with the central axis of the first tubular member, wherein the threaded connection comprises:
a threaded box connector disposed at the end of the first tubular member, wherein the threaded box connector comprises:
a box external shoulder;
a box internal shoulder axially spaced from the box external shoulder;
a plurality of internal threads axially positioned between the box external shoulder and the box internal shoulder;
a box seal surface axially positioned between the internal threads and the box internal shoulder;
a first transition surface extending axially from the internal threads to the box seal surface; and
a second transition surface extending axially from the box seal surface to the box internal shoulder;
wherein the box seal surface has a length Lb-seal measured axially from the first transition surface to the second transition surface;
a threaded pin connector disposed at the end of the second tubular member and threadably coupled to the threaded box connector, wherein the threaded pin connector comprises:
a pin external shoulder that engages the box external shoulder;
a pin internal shoulder axially spaced from the pin external shoulder, wherein the pin internal shoulder engages the box internal shoulder;
a plurality of external threads axially positioned between the pin external shoulder and the pin internal shoulder, wherein the external threads of the threaded pin connector mate with and threadably engage the internal threads of the threaded box connector; and
a pin nose extending axially from the plurality of external threads to the pin internal shoulder, wherein the pin nose includes a pin seal surface that sealingly engages the box seal surface, a major pin nose section extending axially from the external threads to the pin seal surface, and a minor pin nose section extending axially from the pin seal surface to the pin internal shoulder;
wherein the pin seal surface has a length Lp-seal measured axially from the major pin nose section to the minor pin nose section;
wherein the length Lp-seal is greater than the length Lb-seal;
wherein the pin seal surface extends axially from the box seal surface toward the pin external shoulder and the pin seal surface extends axially from the box seal surface toward the pin internal shoulder.

26. The threaded connection of claim 25, wherein the box seal surface has a first end axially adjacent the first transition surface and a second end axially adjacent the second transition surface;
wherein the pin seal surface has a first end axially adjacent the major pin nose section and a second end axially adjacent the minor pin nose section;
wherein the first end of the pin seal surface is axially positioned between the pin external shoulder and the first end of the box seal surface, and wherein the second end of the pin seal surface is axially positioned between the pin internal shoulder and the second end of the box seal surface.

27. The threaded connection of claim 25, wherein the first transition surface is a cylindrical surface, the second transition surface is a cylindrical surface, and the box seal surface is a frustoconical surface.

28. The threaded connection of claim 27, wherein the major pin nose section is defined by a cylindrical surface, the minor pin nose section is defined by a cylindrical surface, and the pin seal surface is defined by a frustoconical surface or an annular convex cylindrical surface.

29. The threaded connection of claim 25, wherein the threaded pin connector has a length Lpin measured axially from the pin external shoulder to the pin internal shoulder;
wherein the pin nose has a length Lp-nose measured axially from the plurality of external threads to the pin internal shoulder;
wherein the major pin nose section has a length Lp-major measured axially from the external threads to the pin seal surface;
wherein the pin seal surface is defined by a frustoconical surface oriented at a taper angle a relative to the central axis of the second tubular member;
wherein the ratio of the length Lp-nose to the length Lpin is greater than or equal to 0.10;
wherein the length Lp-nose is greater than or equal to 1.625 in.;
wherein the ratio of the length Lp-major to the length Lp-nose is greater than or equal to 0.25;
wherein the length Lp-seal is greater than or equal to 0.625 in.;
wherein the taper angle a ranges from 4° to 12°.

30. The threaded connection of claim 29, wherein the ratio of the length Lp-nose to the length Lpin is greater than or equal to 0.20 and less than or equal to 0.30;
wherein the length Lp-nose is greater than or equal to 1.750 in. and less than or equal to 2.750 in.;
wherein the ratio of the length Lp-major to the length Lp-nose is greater than or equal to 0.30 and less than or equal to 0.60;
wherein the length Lp-seal is greater than or equal to 0.750 in. and less than or equal to 1.500 in.;
wherein the taper angle a ranges from 5° to 10°.
